(19) United States
(12) Patent Application Publication
(10) Pub. No.: US 2005/0196148 A1
(43) Pub. Date: Sep. 8, 2005

(54) Recording medium having a data structure for managing font information for text subtitles and recording and reproducing methods and apparatuses

(76) Inventors: Kang Soo Seo, Anyang-si (KR); Byung Jin Kim, Seongnam-si (KR); Jea Yong Yoo, Seoul (KR)

Correspondence Address: HARNESS, DICKEY & PIERCE, P.L.C., P.O. BOX 8910, RESTON, VA, 20195, US

(21) Appl. No.: 11/022,698

(22) Filed: Dec. 28, 2004

Related U.S. Application Data
(60) Provisional application No. 60/542,852, filed on Feb. 10, 2004.
(60) Provisional application No. 60/542,850, filed on Feb. 10, 2004.
(60) Provisional application No. 60/543,328, filed on Feb. 11, 2004.

(30) Foreign Application Priority Data
Feb. 26, 2004 (KR) 10-2004-0013098
Mar. 17, 2004 (KR) 10-2004-0018092

(51) Int. Cl. H04N 7/04

(52) U.S. Cl. 386/95

(57) ABSTRACT

In the data structure for managing font information for text subtitles, a clip information file for a text subtitle stream is provided. The clip information file includes a font file name field for each font file associated with the text subtitle stream. The font file name fields are indexed by a font identifier for each font file associated with the text subtitle stream, and each font file name field provides the font file name of the font file identified by the font identifier. In one embodiment, at least one of the font identifiers identifies a font file referenced as style information in the text subtitle stream.

### CROSS-REFERENCE TO RELATED APPLICATIONS

This application claims the benefit of priority under 35 U.S.C. 119 on Korean Application No. 10-2004-0018092 filed on Mar. 17, 2004, and Korean Application No. 10-2004-0013098 filed on Feb. 26, 2004; which are all hereby incorporated by reference in its entirety.

### BACKGROUND OF THE INVENTION

1. Field of the Invention

The present invention relates to high density recording media such as read-only blu-ray discs (BD-ROM).

2. Discussion of Related Art

Optical discs are widely used as an optical recording medium. Presently, of the optical discs, a new high density optical recording medium (HD-DVD), such as the Blu-ray Disc (hereafter called as “BD”), for recording and storing a large amount of high definition video and audio data is under development.

Currently, global standard technical specifications of the Blu-ray Disc (BD), a next generation HD-DVD technology, are being established as a next generation optical recording solution that can store amounts of data significantly surpassing present DVDs.

In relation to this, development of optical reproducing apparatuses for the Blu-ray Disc (BD) standards has also started. However, the Blu-ray Disc (BD) standards are not complete yet, and there has been difficulty in developing a complete optical reproducing apparatus.

Particularly, for effective reproduction of data from the Blu-ray Disc (BD), in addition to main AV data, various kinds of other data may be reproduced for the convenience of a user, such as supplementary or supplemental data (e.g., interactive graphics data, subtitle data, etc.) related to the main AV data. Accordingly, managing information should be provided for managing reproduction of the main data and the supplemental data. However, in the present Blu-ray Disc (BD) standards, because consolidated standards for managing the various data, particularly the supplemental data are not complete yet, there are many restrictions on the development of a Blu-ray Disc (BD) optical reproducing apparatus.

### SUMMARY OF THE INVENTION

A recording medium according to the present invention includes a data structure for managing font information for text subtitles.

In one embodiment, the recording medium stores a clip information file for a text subtitle stream. The clip information file includes a font file name field for each font file associated with the text subtitle stream. The font file name fields are indexed by a font identifier for each font file associated with the text subtitle stream, and each font file name field provides the font file name of the font file identified by the font identifier. In one embodiment, at least one of the font identifiers identifies a font file referenced as style information in the text subtitle stream.

In another embodiment, the recording medium stores a clip information file for a text subtitle stream that includes an application type indicator indicating text subtitle as an application type. The clip information file also includes a font file name field for each font file associated with the text subtitle stream. The font file name fields are indexed by a font identifier for each font file associated with the text subtitle stream, and each font file name field provides the font file name of the font file identified by the font identifier.

In yet another embodiment, the recording medium stores a clip information file for a text subtitle stream, and the clip information file for the text subtitle stream includes at least one font file name field. Here, each font file name field is indexed by a font identifier, and each font file name field provides the font file name of the font file, which is a separate file from the text subtitle stream. At least one of the font identifiers is in the text subtitle stream for referencing the font file.

The present invention further provides apparatuses and methods for recording and reproducing the data structure according to the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a file structure for managing various data on a disc in accordance with an example embodiment of the present invention;

FIG. 2 illustrates a format of a disc on which the file structure of FIG. 1 is recorded in accordance with an example embodiment of the present invention;

FIG. 3 illustrates a data structure and method for recording reproduction management information of main AV data and supplemental data streams;

FIGS. 4A and 4B illustrate diagrams showing examples in which a main AV stream and supplemental data, particularly, a text subtitle are provided at the same time;

FIG. 5 illustrates a diagram showing a ClipInfo( ) syntax for supplemental data clip information in accordance with an example embodiment of the present invention;

FIG. 6 illustrates a diagram showing a SequenceInfo( ) data structure syntax for supplemental data clip information in accordance with an example embodiment of the present invention;

FIG. 7 illustrates a diagram showing an STC-sequence of a text subtitle clip in accordance with an example embodiment of the present invention;

FIG. 8 illustrates a diagram showing a ProgramInfo( ) data structure syntax for supplemental data clip information in accordance with an example embodiment of the present invention; and

FIG. 9 illustrates a block diagram of an optical recording and reproduction apparatus in accordance with an example embodiment of the present invention.

### DETAILED DESCRIPTION OF THE EXEMPLARY EMBODIMENTS

Reference will now be made in detail to the embodiments of the present invention, examples of which are illustrated in the accompanying drawings. Though words used in the present invention are selected from widely used general words, there are words the applicant has selected at his discretion and the detailed meanings of these words are described in relevant parts of the description of the present invention. As such, the present invention is to be understood by meanings of the words provided in the disclosure.

In relation to above, main data in the present invention means main data or information on the recording medium (e.g., an optical disc) such as a title of video and audio data an author provides to a user, in general, recorded in the MPEG2 format, and often referred to as a main AV stream.

Supplementary, supplemental or auxiliary data means all data related to the main data provided to a user for convenience of reproduction, including, for example, an auxiliary audio stream as a background music; interactive graphic stream, such as PopUp menu, a click sound interactive with the user; and subtitle information such as caption information and words of a song.

Therefore, depending on the nature of the supplementary data, the supplemental data is recorded multiplexed with a main AV stream in the MPEG2 format, or is recorded as a stream file in the MPEG2 or other format independent from the main AV stream.

Caption information is information generally displayed at one side of a screen when the user selects a subtitle of a language the optical disc supports and intends to watch a video (the main AV data) with a caption of that language.

The PopUp menu, introduced for providing different menus depending on the nature of data in an associated reproduction unit, is menu information provided in a small window of a display screen without changing reproduction of a picture under reproduction. The PopUp menu may be displayed overlapping the picture under reproduction. Because of this, the menu information is referred to as a “PopUp” menu.

The click sound is a brief sound provided upon selection of a menu button, or a shift in selection, and calls a user's attention to the fact that a selection has been made. Depending on the use of the click sound, the click sound is sometime referred to as a “menu sound”.

In the present invention, the “subtitle” as supplemental data may be caption information, presentation graphic information, etc. such as the text of a song. Therefore, the subtitle may be written in various formats such as MPEG2 transport (TS) packets, bit-map form of binary format, or text data (e.g., character data). A subtitle recorded in the form of text data may be referred to as a “text subtitle”.

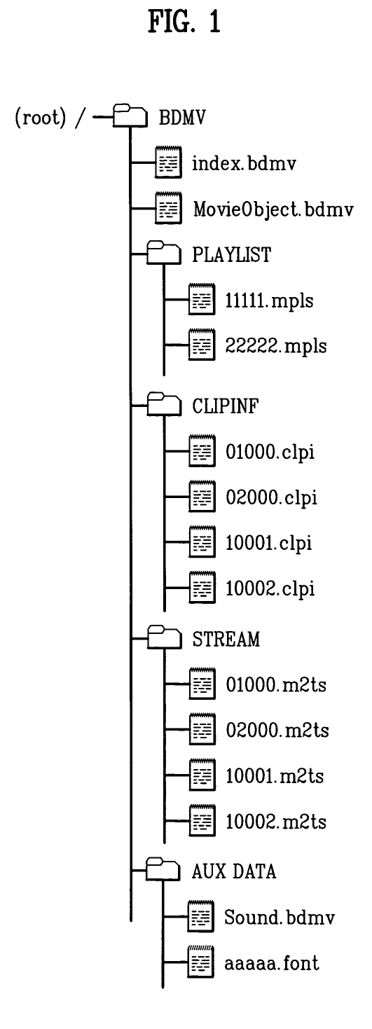

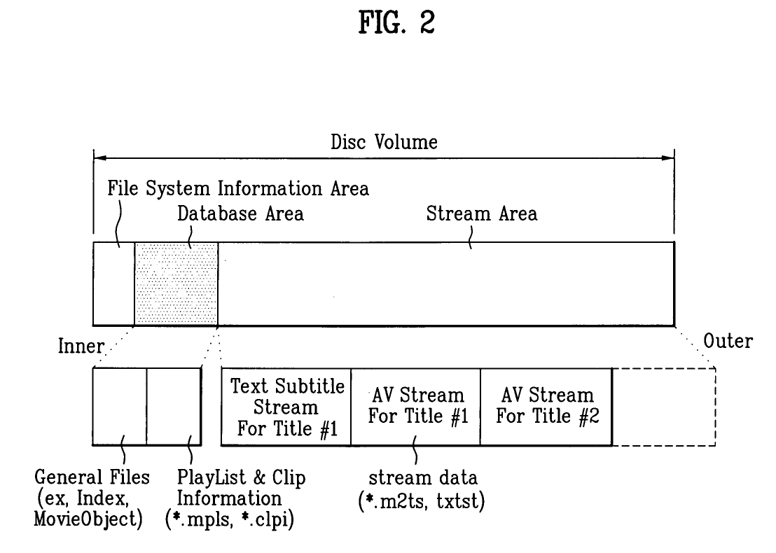

A format for recording main data and supplementary data on the recording medium such as a BD disc, and a file structure for managing the data will be described in detail with reference to FIGS. 1 and 2.

FIG. 1 illustrates a file structure for managing various data on a disc in accordance with an example embodiment of the present invention. As shown, the file structure includes at least one BD directory BDMV, under a root directory, having an index file index.bdmv and an object file MovieObject.bdmv as general files (upper files) for securing user interactivity. For example, the index file index.bdmv is constructed centered on an index table having menu information and title information the user can select. The BD directory also includes a playlist directory PLAYLIST, a clipinfo directory CLIPINF, a stream directory STREAM, and an auxiliary directory AUX DATA.

The stream directory STREAM has files on a main video and audio stream (called a main AV stream) recorded in MPEG2 transport packets. Because the main AV stream is record in the MPEG2 format, the file name extension of the main AV stream files (e.g., 01000.m2ts and 02000.m2ts) will be “*.m2ts”. The STREAM directory may also include supplemental data streams recorded in the MPEG2 format. For example, FIG. 1 shows text subtitle streams 10001.mt2s and 10002.mt2s in the STREAM directory. When a text subtitle or other supplemental data stream is recorded in the STREAM directory, a file name extension other than “*.mt2s” may be used. For example, “*.txtst” may be used as the file name extension for text subtitle stream files. Also, as discussed below, these supplemental data streams may, instead, be stored in the AUX DATA directory.

Meanwhile, the streams of supplementary or supplemental data, provided for convenience of the user during reproduction of the main data may be provided in a separate directory—the AUX DATA directory—when the supplemental data stream files are independent of the main data stream files. The AUX DATA directory has supplemental or auxiliary data streams such as text subtitle (not shown), Font (aaaaa.font), popup PopUp (not shown), click sound (Sound.bdmv), etc. The supplemental data such as interactive graphics (e.g., a PopUp menu) and a subtitle (e.g., a text subtitle) are related to the main AV stream, and may be supported by other supplemental data such a sound file and font file. For example, the sound file may include the click sound reproduced in association with a user's selection from the PopUp menu, and the font file may include a font used to reproduce the text subtitle. Some of the supplementary data streams, such as audio information for a browsable slide show, are multiplexed with the main data stream, and therefore these supplementary data streams are included in the stream directory STREAM. The supplemental data streams in the AUX DATA directory are not multiplexed with the main data stream. And, non-MPEG2 streams are recorded in the AUX DATA directory.

The clipinfo directory CLIPINF has clipinfo files (e.g., 01000.clpi, 02000.clpi, and 10001.clpi, and 10002.clpi) having a one-to-one correspondence with each stream file (e.g., main AV and text subtitle) and some of the AUX DATA files *.m2ts, and *.txt. Particularly, the clipinfo file *.clpi has attribute information and timing information of an associated file. The timing information includes information on mapping a presentation time stamp (PTS) of data in the associated file to a source packet number of a source packet in the file. Typically this map is referred to as an entry point map (EP Map). In the BD standard, the stream *.m2ts, *.txt files, or etc. and the associated clipinfo file *.clpi (e.g., 01000.cpli and 01000.txtst) are called a “clip”, collectively.

The playlist directory PLAYLIST includes a playlist file (*.mpls), and at least one playitem for designating a playing interval of a particular clip. Therefore, the playitem has information on a play starting time In-Time and play end time Out-Time of a particular clip desired to play, i.e., designated by a clip name Clip_Information_File_Name in the playitem. The playlist file *.mpls provides basic play file information for playing a desired clip by providing at least one playitem. Moreover, the playlist file *.mpls may be provided with a subplayitem SubPlayItem for reproduction management of the supplementary data. As discussed in detail below, the subplayitem provides some of the same management information as a playitem, but for reproduction of supplemental data. Also, when a subplayitem SubPlayItem is provided for reproduction of a text subtitle, the text subtitle data may be reproduced synchronized with an associated playitem PlayItem (as discussed in greater detail below). As another example, when a subplayitem SubPlayItem is provided for reproduction of a browsable slide show, the slide show data may be played non-synchronized with an associated playitem PlayItem.

As shown in FIG. 2, the disc volume of a BD-ROM is organized into a File System Information Area, a Database Area, and a Stream Area. The File System Information Area stores system information for managing the disc. The Database Area includes a general files area and a playlist and clip information area. The general files area stores general files such as the index.bdmv file and the MovieObject.bdmv file. The playlist and clip information area stores the PLAYLIST directory and the CLIPINF directory. The main data and the supplemental data are recorded in the Stream Area. According to this, a reproducing apparatus determines the main data and the supplementary data desired to reproduce, by using file information in the Database Area and/or stream management information in the Stream Area.

Next, data structures and information for managing the reproduction supplementary data will be described in detail. Also methods for recording the management information, and methods for reproducing the supplemental data using the recorded management information will be described in detail.

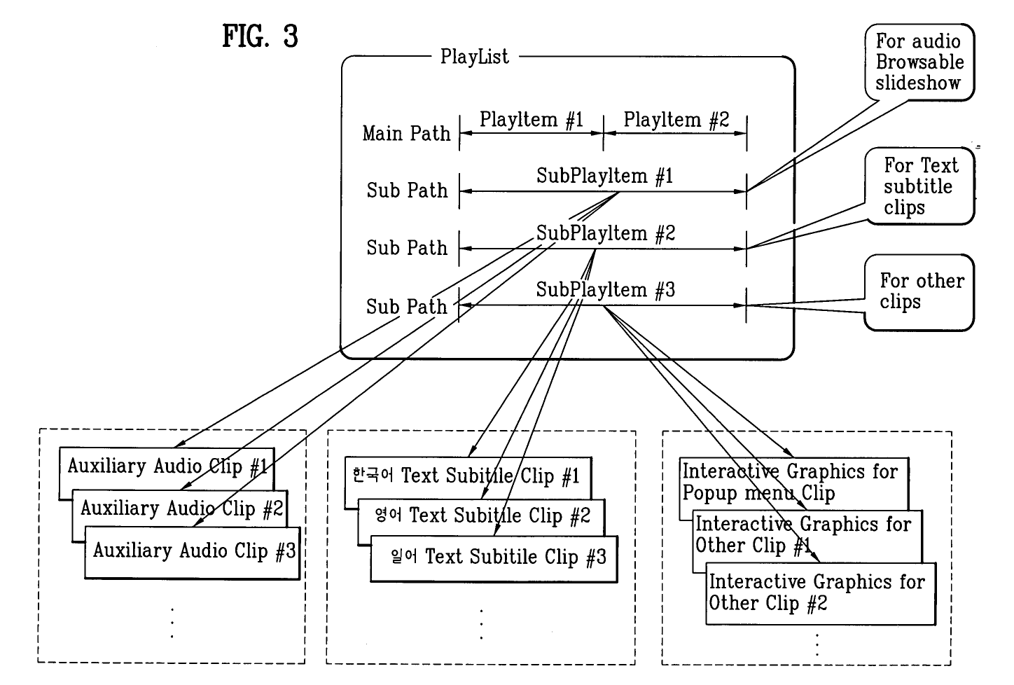

FIG. 3 illustrates a data structure and method for recording reproduction management information of main AV data and supplemental data streams. As shown, a particular title for reproduction may be managed by a playlist file PlayList, and the main AV data is recorded in a main clip Main Clip (not shown). More specifically, in this instance, the one main clip Main Clip may be managed by a plurality of playitems PlayItem #1 and PlayItem #2. Also, different main clips Main Clip may be managed by a plurality of playitems within one playlist PlayList.

The supplemental data that supplements the main AV data are recorded in separate clips and managed by subplayitems, for example, SubPlayItems#1, #2 and #3. As shown, a SubPath exists for each supplemental data type and the subplayitems are organized by SubPath.

That is, the supplemental data is sorted according to clip types, and managed by a plurality of subplayitems. For example, audio clips #1, #2 and #3 for a browsable slide show may be a clip managed by a first subplayitem SubPlayItem #1 in one SubPath, and a plurality of text subtitle clips Text Subtitle Clips #1, #2 and #3 for supporting caption information of Korean, English, Japanese, respectively, may be clips managed by a subplayitem SubPlayItem #2 in another SubPath. Of the supplementary data, a plurality of other clips (e.g., PopUp, etc.) excluding the audio clip and the text subtitle clips may be managed by a subplayitem SubPlayItem #3 in yet another SubPath.

Thus, an example file structure of the present invention has a structure in which the clips are managed by a subplayitem for each clip type (e.g., each supplemental data or SubPath type).

More specifically, in order to be represented in various languages (e.g., Korean, English, etc.), a plurality of text subtitle clips may each be independently formed. And, herein, a single SubPlayItem manages the plurality of text subtitle clips. In addition, font file information of the text subtitle streams is recorded in the clip information area (e.g., ClipInfo area), as discussed in detail below, for the text subtitle clips having the above-described structure. Subsequently, when reproducing the PlayList, the file having the text subtitle clips recorded therein and the related font files may preloaded to a buffer and used.

The playitem PlayItem in the PlayList has reproduction management information for reproducing the main data, and the subplayitems SubPlayItem have reproduction management information for reproducing the supplemental data. Particularly, as described before, as part of the reproduction managing information, the playitem and subplayitems provide reproduction starting time In-time and a reproduction end time Out-Time for each associated clip.

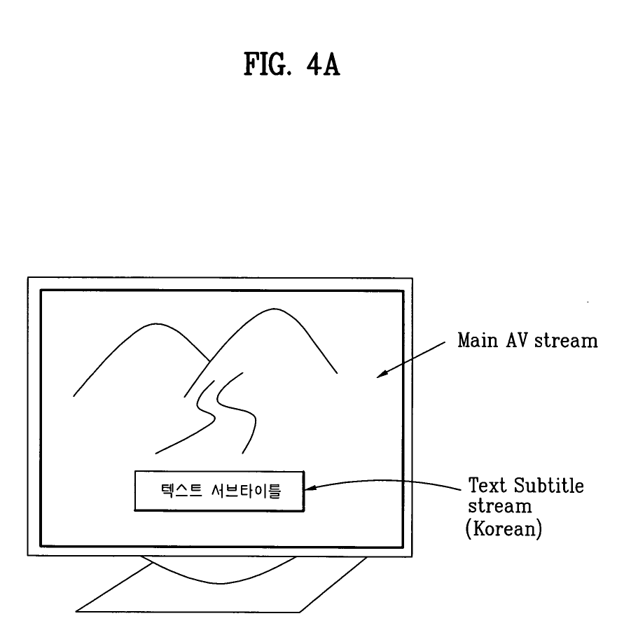

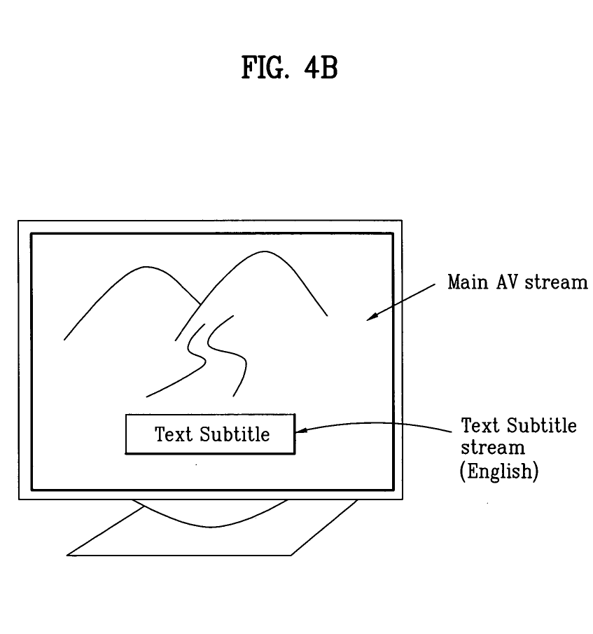

FIGS. 4A and 4B illustrate diagrams showing examples in which a main AV stream and supplemental data, particularly, a text subtitle are provided at the same time. FIG. 4A illustrates an example of a case when a text subtitle is in Korean as the caption information, and FIG. 4B illustrates an example of a case when a text subtitle is in English as the caption information. The text subtitles of Korean and English exist as independent clips, and are displayed, based on user selection, at one side of the display screen, separate from and overlapping with the main AV stream.

Next, the syntax of the data structures according to embodiments of the present invention will be described.

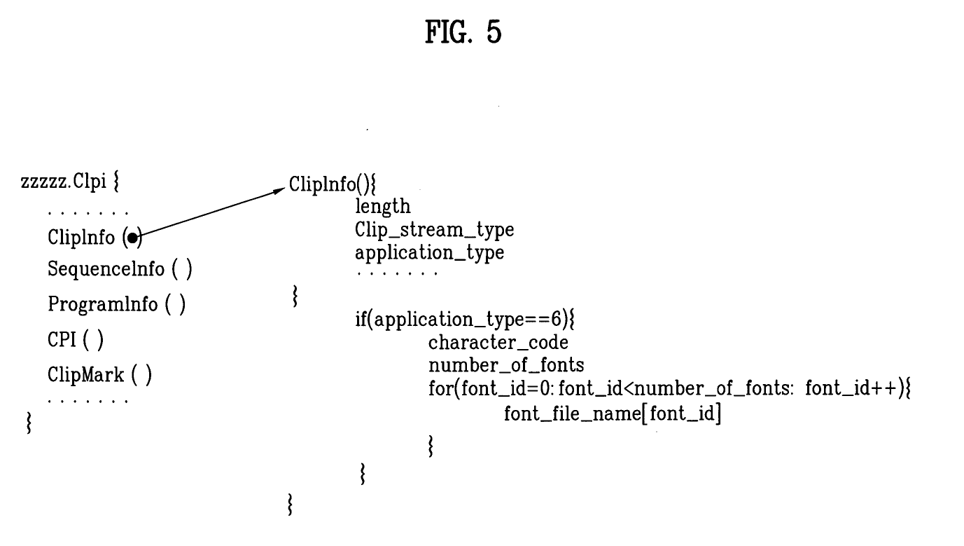

FIGS. 5˜6 illustrate data structures and methods for including information on supplementary data clips managed by subplayitems in accordance with example embodiments of the present invention.

FIG. 5 illustrates a diagram showing a ClipInfo( ) syntax for a supplemental data clip information in accordance with an example embodiment of the present invention. As shown, the clip info file zzzzz.Clpi having application information and time information on respective stream files *.m2ts, *.txtst, etc. has five data structure objects: ClipInfo( ), SequenceInfo( ), ProgramInfo( ), CPI( ), and ClipMark( ).

The “ClipInfo( )” data structure includes, among other things, a length field, a “Clip_stream_type” field and an “application_type” field. The length field indicates a length of the “ClipInfo( )” data structure. The “Clip_stream_type” field designates a type of data stream, wherein the type is set to 1 for both a main AV stream and a text subtitle stream.

The “application type” field indicates the application type of the clip. An “application_type” field of ‘1’ indicates a transport stream for a movie application Movie application, an “application_type” field of ‘2’ indicates a transport stream for a time based slide show, an “application_type” field of ‘3’ indicates a transport stream for a browsable slide show main path, an “application_type” field of ‘4’ indicates a transport stream for an audio presentation of a browsable slide show subpath, an “application_type” field of ‘5’ indicates a transport stream for an interactive graphic stream subpath, and an “application_type” field of ‘6’ indicates a transport stream for a text subtitle stream subpath. That is, according to the “application_type”, applications of respective streams are defined.

When the “application_type” is 6 (i.e., a case of the text subtitle stream), the ClipInfo( ) data structure includes a “character_code” field for defining a character code value, a “number_of_fonts” field for defining a number of fonts, and a “font_file_name[font_id]” field for defining a file name of each for the number of fonts.

Table 1 below shows character code values that may be used in the “character_code” field.

TABLE 1

| Value | Character code | Encoding |
|---|---|---|
| 0x00 | Reserved | |
| 0x01 | Unicode V1.1 (ISO 10646-1) | UTF8 |
| 0x02 | Unicode V1.1 (ISO 10646-1) | UTF16 big endian |
| 0x03 | GBK18030-2000 (Chinese) | N.A |
| 0x04 | GB2312 (Chinese) | N.A |
| 0x05 | BIG5 (Chinese) | N.A |
| 0x06 | Shift JIS (Japanese) | N.A |
| 0x07 | KSC 5601-1987 including KSC 5653 | N.A |
| | for Roman character (Korean) | |
| others | Reserved | |

A character code value may be designated and used according to values in table 1, and particularly, the characters may be recorded in Big Endian form in the text subtitle stream.

As shown in FIG. 5, the font_id increments from 0 to the number of fonts indicated in the “number_of_fonts” field. The “font_file_name [font_id]” field, therefore, provides a list of font file names in the AUX DATA directory, as indexed by the font_id. Stated another way, the “font_file_name [font_id]” field provides the font file name of the font file identified by the font_id. The named font files are referenced in the text subtitle stream associated with the clip information file.

More specifically, the text subtitle stream includes a dialog style segment and one or more dialog presentation segments. The dialog style segment provides style information for subtitle data in the dialog presentation segments. This style information may include a reference to a font file. In referencing the font file, the dialog style information uses the same font_id as in the clip information file for the text subtitle stream. Similarly, a dialog presentation segment may also include line specific style information that may also include a reference to a font file using the same font_id as in the clip information file for the text subtitle stream. Dialog style and presentation segments are discussed in greater detail in application Ser. No. UNKNOWN, titled RECORDING MEDIUM HAVING A DATA STRUCTURE FOR MANAGING TEXT SUBTITLES AND RECORDING AND REPRODUCING METHODS AND APPARATUSES filed concurrently herewith and which is hereby incorporated by reference in its entirety.

Each font file name is of the format “aaaaa.font” file or “aaaaa.otf” (not shown) where “aaaaa” is a five digit number. During reproduction, a font file designated by the “font_file_name[font_id]” field may be preloaded on a buffer before reproduction of the playlist.

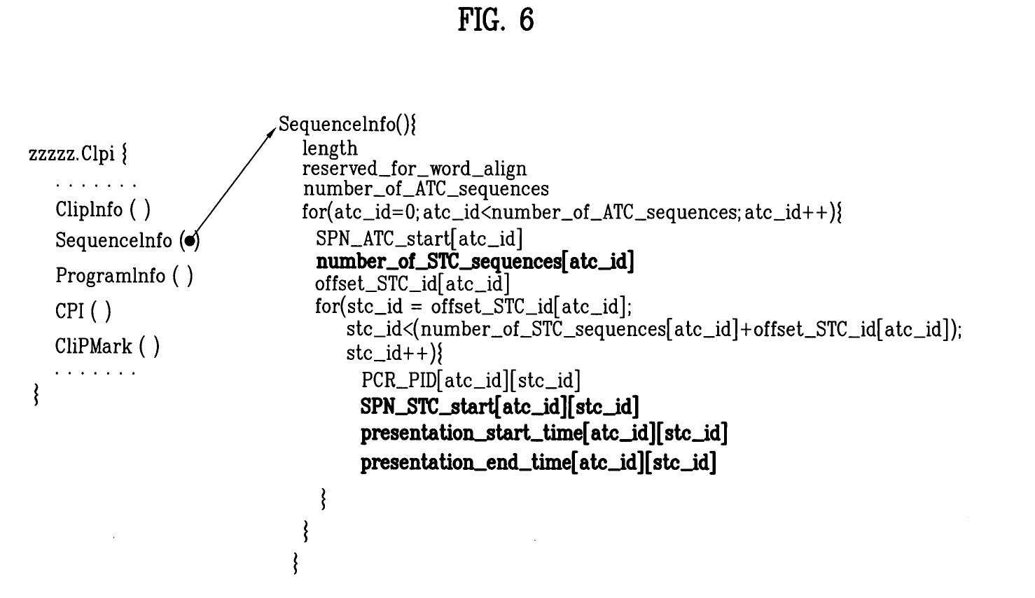

FIG. 6 illustrates a diagram showing a SequenceInfo( ) data structure syntax for supplemental data clip information in accordance with an example embodiment of the present invention. As shown, of the five data structure objects of the clip info file zzzzz.Clpi, the SequenceInfo( ) data structure has a length field indicating a length of the SequenceInfo and a “number_of_ATC sequences” field indicating a number of ATC (Arrival Time Clock)-sequences. “SPN_ATC_start[atc_id]” field information, “number_of_STC_sequence[atc_id]” field information, and “offset_STC_id” field information are provided for each ATC sequence by incrementing the ATC_id index by one starting from “0” (i.e., ATC_id=0) until the number of the ATC-sequences is reached.

In case of the text subtitle, the “number_of_STC_sequences [atc_id]” field representing the total number of the ATC-sequences should be equal to 1. In other words, each of the text subtitle files is formed of a single ATC-sequence. More specifically, when the text subtitle stream is recorded on the high density optical disc, the text subtitle stream is formatted into a BD source packet formed of 192 bits and then recorded, and each source packet includes an arrival time stamp (ATS) formed of 4 bits. At this point, the ATS continuously increases in accordance with the entire source packets included in the text subtitle file. And, since a single ATC-sequence should be formed to have no discontinuity therein, the ClipInfo( ) being related to all of the text subtitle files should always be set to “number _of_ATC_sequences=1”.

The “SPN_ATC_start[atc_id]” field provides a Source Packet Number (SPN) of a starting position of the ATC-sequence designated by atc_id of the stream file, the “offset_STC_id” field provides an offset_stc_id value of a first STC-sequence, and the “number_of_STC_sequences[atc_id]” indicates a number of the STC (System Time Clock)-sequences in the ATC-sequence designated by atc_id. In the case of a text subtitle stream, the number of the STC-sequences is set to ‘1’.

Moreover, by incrementing an STC_id from the offset value given in the “offset_STC_id[atc_id]” field to a number obtained by adding the offset value to the number in the “number_of_STC_sequence[atc_id]” field, the following fields are provided “PCR_PID[atc_id][stc_id]” field, “SPN_STC_start [atc_id][stc_id]” field, “presentation_start_time [atc_id][stc_id]” field, and “presentation_end_time [atc_id][stc_id]” field.

The “PCR_PID [atc_id][stc_id]” field indicates a value of the PID of transport packets that contain PCR fields valid for the STC-sequence designated by the stc_id in the ATC-sequence designated by the atc_id. The “SPN_STC_start [atc_id][stc_id]” field indicates the source packet number SPN at a starting position of the STC-sequence designated by the stc_id in the ATC-sequence designated by the atc_id. In the case of a text subtitle stream, the field is set to ‘1’.

The “presentation_start_time [atc_id][stc_id]” field, and “presentation_end_time [atc_id][stc_id]” field indicate a start time and end time, respectively, of the STC_sequence designated by the stc_id of the ATC-sequence designated by the atc_id in the AV stream. In the case of a text subtitle stream, the starting time is set to ‘0’, and the end time is the same as an end time of a last presentation.

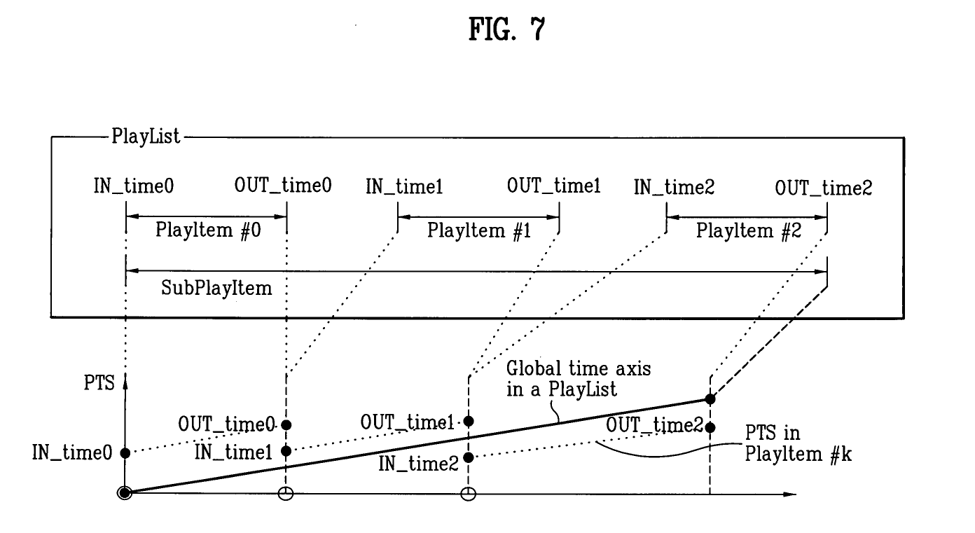

FIG. 7 illustrates a diagram showing an STC-sequence of a text sub-title clip in accordance with an example embodiment of the present invention. As shown, in an HDMV movie represented with a plurality of playitems PlayItems # 1, #2 and #3, the text subtitles that one subplayitem SubPlayItem manages has one STC-sequence, and the STC-sequence is expressed using the same global time axis as the playlist PlayList.

More specifically, when the PlayItems included in a random PlayList have different time information (i.e., when the clips included in the PlayList are formed based on different STC information), as shown in FIG. 7, the global time axis is a time axis used for converting the different time information of each PlayItem into a single continuous time information. Therefore, the data of the text subtitles should be formed based on the PlayList and not on each individual PlayItem. And, in order to reduce the decoding process, a presentation time for each data unit (e.g., a dialog or a dialog style unit (DSU)) should be determined based on the global time axis having a continuous value within the PlayList and included in the stream. Accordingly, since the stream of all text subtitle files is formed based on the information of a single continuous time axis, the text subtitle files is also formed of a single STC-sequence. In other words, the ClipInfo( ) area related to all text subtitle files is always represented as “number_of_STC sequences=1”.

Moreover, as described above, the start time of the STC-sequence is 0, and the end time is equal to the end time of the last presentation. At this point, in order to decode a text subtitle having a single STC-sequence, as described above, the decoder should be aware of the information related to the STC discontinuity point (ref. the small circles of FIG. 7) of the main AV clips in the PlayList.

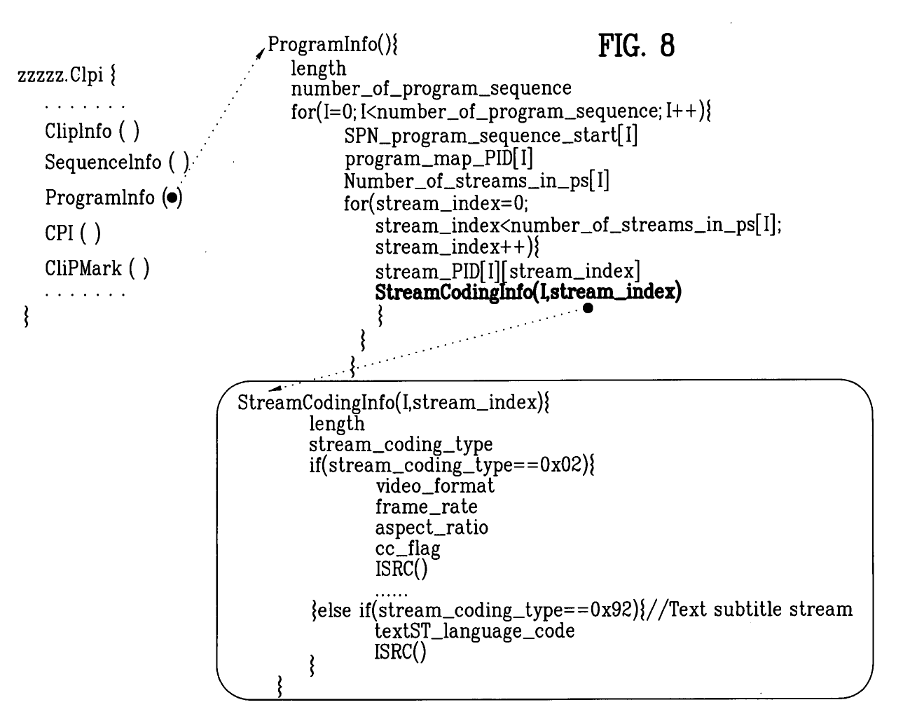

FIG. 8 illustrates a diagram showing a ProgramInfo( ) data structure syntax for supplemental data clip information in accordance with an example embodiment of the present invention. The program sequence is a continuous group of source packets related to the contents of a program. As shown, of the five data structure objects of the clip info file zzzzz.Clpi, the ProgramInfo( ) data structure has a length field, and a “number_of_program_sequence” field. The length field indicates the length of the ProgramInfo data structure, and the “number_of_program_sequence” field indicates the number of program sequences managed by the ProgramInfo data structure. For a text subtitle stream, the number of program sequences is set to 1. In other words, only the text subtitle stream exists in the text subtitle clip.

For each program sequence, indexed by I, the data structure includes, an “SPN_program_sequence_start[I]” field, a “program_map_PID[I]” field, and a “number_of_streams_in_ps[I]” field. The “SPN_program_sequence_start[I]” field indicates the source packet (SPN) of the start of the Ith program sequence. The “program_map_PID[I]” field indicates the PID value of the transport packets that contain the program_map_section of the Ith program sequence. The “Number_of_streams_in_ps[I]” field indicates the number of elementary streams in the Ith program sequence. For each stream indexed by a stream_index, the data structure further includes a “stream_PID [I]” field, a “StreamCodingInfo (I, stream_index)” field, and the like. The “Stream_PID[I][stream_index]” field indicates the PID value of the transport packets for the elementary stream designated by the stream index stream_index for the program sequence designated by the sequence index I. The “StreamCodingInfo (I, stream_index)” field has coding information on an elementary stream of the main AV stream and the supplementary data stream.

The “StreamCodingInfo (I, stream_index)” field, having coding information on the elementary stream includes a “length” field for indicating a length of the “StreamCodingInfo (I, stream_index)” field, and a “stream_coding_type” field for indicating a coding type of the elementary stream. This latter field has coding information on various forms of streams depending on the coding type of the elementary stream.

For example, the stream_coding_type of 0x02 indicates coding information of an MPEG2 video stream, the stream_coding_type of 0x80 indicates coding information of HDTV LPCM audio, the stream_coding_type of 0x81 indicates coding information of an Dolby AC-3 audio, the stream_coding_type of 0x82 indicates coding information of a dts audio, the stream_coding_type of 0x90 indicates coding information of a presentation graphic stream, and the stream_coding_type of 0x92 indicates coding information of a text subtitle stream (for convenience of description, FIG. 8 illustrates cases of the stream_coding_type of 0x02, and 0x92).

In the case of stream_coding_type=0x02, video_format, frame_rate, aspect_ratio, cc_flag and ISRC( ) fields are provided. The first three fields are self-explanatory, the cc_flag indicates whether Line 21 information of a 525/60 TV system is included in the stream, and the ISRC field indicates the applicable International Standard Recording Code.

In the case of the stream_coding_type of 0x92 (i.e., in the case of the text subtitle stream), language information on the text subtitle clip may be included by using the “textST_language_code” field. By inserting language information via the language_code in the text subtitle clip information, the clip information of the text subtitle may be first retrieved and stored, and then used for selectively reproducing a language subtitle the user wants during reproduction of, for example, main AV data.

The entire set or a subset of the above-described data structures may be used together or independently. Also, it is apparent that a plurality kinds of clip information may be selected by a subplayitem using any of the methods described above.

The five data structure objects of the clip info files in FIGS. 6 and 8 for zzzzz.clpi, also include a CPI data structure indicating a relation between time information and address information of the AV stream and a ClipMark( ) data structure not presently defined. A detailed description of these two data structures will be omitted because there is no substantial relation with the present invention.

Each of the text subtitles, having a wide range of language information, is formed as an independent clip. These clips are managed by a SubPlayItem. Font information and sequence information for the text subtitles are recorded in the clip information area (i.e., ClipInfo area) of the text subtitle clip. Accordingly, a syntax of the ClipInfo area may be formed in accordance with the embodiments of the present invention.

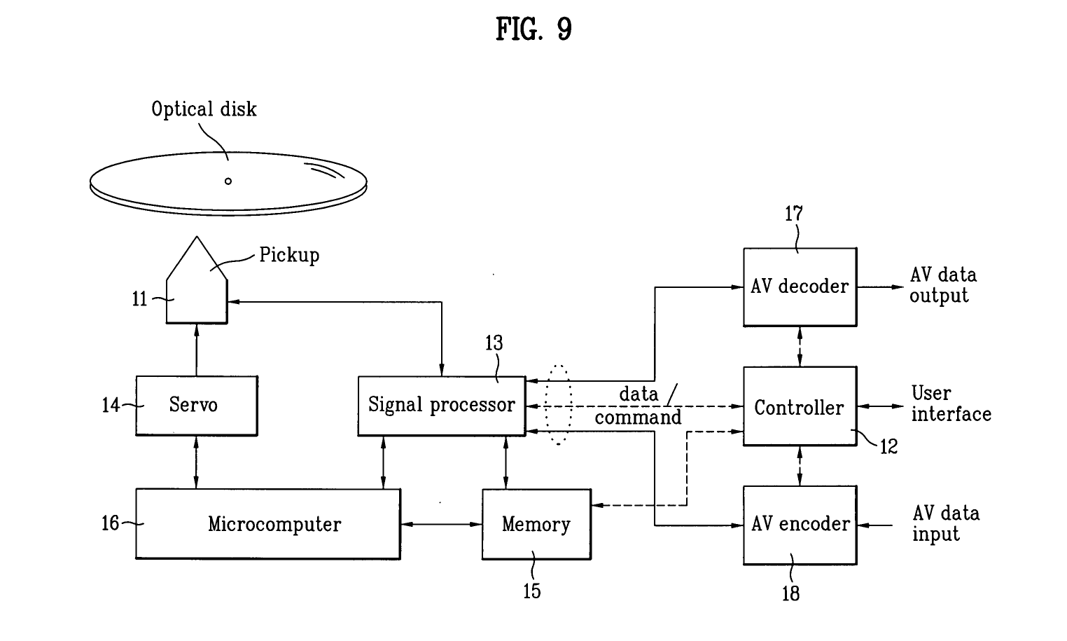

FIG. 9 illustrates an optical recording and reproduction apparatus in accordance with an embodiment of the present invention. As shown, the apparatus includes a pickup 11 (an optical pick-up) for reading managing information, main data and supplemental data recorded on the optical disc; a servo 14 for controlling operation of the pickup 11; a signal processing portion 13 for restoring a reproduced signal received from the pickup 11 into a desired signal value, or demodulating a signal-to-be-recorded into a signal to be written on the optical disc; a memory 15 for preloading and temporary storage of reproduction managing information including the supplementary data; and a microcomputer 16 for controlling the above operations.

In relation to above, in the present invention, the memory 15 represents various storage means (RAM, buffer, and the like) that may exist in the optical recording and reproduction apparatus, and it is apparent that the memory 15 may be replaced with a plurality of storage devices of different types.

The apparatus further includes, as shown, an AV decoder 17 that decodes the output data, and provides the decoded output data to a user under the control of a controlling portion 12 (e.g., a processor). Also, an AV encoder 18 converts an input signal into a signal of a particular format, for an example, the MPEG2 TS transport stream, and provides the encoded signal to the signal processing portion 13, under the control of the controlling portion 12, to write the signal on the optical disc.

The controlling portion 12, a portion for controlling operation of the entire optical recording and reproduction apparatus, reads the corresponding playitem and the subplayitem information in the playlist file in response to a user's instruction for reproducing a particular title (e.g., a main AV stream) received via a user interface. The controlling portion 12 controls the apparatus to reproduce the playitem PlayItem and the subplayitem SubPlayItem according to the reproduction management information included in the read playitem PlayItem and subplayitem SubPlayItem information as discussed above with respect to FIGS. 1-8.

For example, in accordance with one embodiment of the present invention, the clip information of text subtitles may be stored in the memory 15 by pre-loading, and selectively reproduced according to the language the user selects.

The controlling portion 12 also controls the apparatus to record the data structures (including the language information) discussed above with respect to FIGS. 1-8. A portion of this management information may be received via the user interface and sent to the signal processing portion 13 for writing onto the optical disc.

While the invention has been disclosed with respect to a limited number of embodiments, those skilled in the art, having the benefit of this disclosure, will appreciate numerous modifications and variations there from. For example, while described with respect to a Blu-ray ROM optical disk in several instances, the present invention is not limited to this standard of optical disk or to optical disks. It is intended that all such modifications and variations fall within the spirit and scope of the invention.

1. A recording medium having a data structure for managing font information for text subtitles, comprising:
a recording area storing a clip information file for a text subtitle stream, the clip information file including a font file name field for each font file associated with the text subtitle stream, the font file name fields being indexed by a font identifier for each font file associated with the text subtitle stream, each font file name field providing the font file name of the font file identified by the font identifier, and at least one of the font identifiers identifying a font file referenced as style information in the text subtitle stream.

2. The recording medium of claim 1, wherein the clip information file includes an application type indicator indicating text subtitle as an application type.

3. The recording medium of claim 1, wherein the font file name in each font file name field is a five digit number.

4. The recording medium of claim 1, wherein the clip information file includes a number of fonts indicator indicating the number of font files managed by the clip information file.

5. The recording medium of claim 4, wherein the font identifiers have incremental values from zero to the number of fonts indicated by the number of fonts indicator.

6. The recording medium of claim 1, wherein at least one of the font identifiers identifies a font file referenced as style information in a presentation segment in the text subtitle stream.

7. The recording medium of claim 1, wherein the recording area stores the font files and a text subtitle stream file containing the text subtitle stream as separate files.

8. The recording medium of claim 7, wherein the recording area stores a STREAM directory including the text subtitle stream file and an AUX DATA directory including the font files.

9. The recording medium of claim 8, wherein the recording area stores a CLIPINF directory including the clip information file.

10. The recording medium of claim 8, wherein the STREAM directory stores MPEG2 formatted files and the AUX DATA directory stores non-MPEG2 formatted files.

11. A recording medium having a data structure for managing font information for text subtitles, comprising:
a recording area storing a clip information file for a text subtitle stream, the clip information file including an application type indicator indicating text subtitle as an application type and including a font file name field for each font file associated with the text subtitle stream, the font file name fields being indexed by a font identifier for each font file associated with the text subtitle stream, each font file name field providing the font file name of the font file identified by the font identifier.

12. A recording medium having a data structure for managing font information for text subtitles, comprising:
a recording area storing a clip information file for a text subtitle stream, the clip information file for the text subtitle stream including at least one font file name field, each font file name field being indexed by a font identifier, each font file name field providing the font file name of the font file, which is a separate file from the text subtitle stream, and at least one of the font identifiers is in the text subtitle stream for referencing the font file.

13. A method of reproducing a data structure for managing font information for text subtitles from a recording medium, comprising:
reproducing a clip information file for a text subtitle stream from the recording medium, the clip information file including a font file name field for each font file associated with the text subtitle stream, the font file name fields being indexed by a font identifier for each font file associated with the text subtitle stream, each font file name field providing the font file name of the font file identified by the font identifier, and at least one of the font identifiers identifying a font file referenced as style information in the text subtitle stream.

14. The method of claim 13, further comprising:
storing the reproduced clip information file in a buffer.

15. The method of claim 14, wherein the reproducing step and the storing step are performed before reproducing the text subtitle stream.

16. A method of recording a data structure for managing font information for text subtitles on a recording medium, comprising:
recording a clip information file for a text subtitle stream on the recording medium, the clip information file including a font file name field for each font file associated with the text subtitle stream, the font file name fields being indexed by a font identifier for each font file associated with the text subtitle stream, each font file name field providing the font file name of the font file identified by the font identifier, and at least one of the font identifiers identifying a font file referenced as style information in the text subtitle stream.

17. An apparatus for reproducing a data structure for managing font information for text subtitles from a recording medium, comprising:
a driver for driving an optical reproducing device to reproduce data recorded on the recording medium;
a controller for controlling the driver to reproduce a clip information file for a text subtitle stream from the recording medium, the clip information file including a font file name field for each font file associated with the text subtitle stream, the font file name fields being indexed by a font identifier for each font file associated with the text subtitle stream, each font file name field providing the font file name of the font file identified by the font identifier, and at least one of the font identifiers identifying a font file referenced as style information in the text subtitle stream.

18. The method of claim 17, further comprising:
a buffer; and wherein
the controller stores the reproduced clip information file in the buffer.

19. The method of claim 18, wherein the controller controls the reproduction of the clip information file and the storing of the clip information file in the buffer before controlling reproduction of the text subtitle stream.

20. An apparatus for recording a data structure for managing font information for text subtitles on a recording medium, comprising:
a driver for driving an optical recording device to record data on the recording medium;
a controller for controlling the driver to record a clip information file for a text subtitle stream on the recording medium, the clip information file including a font file name field for each font file associated with the text subtitle stream, the font file name fields being indexed by a font identifier for each font file associated with the text subtitle stream, each font file name field providing the font file name of the font file identified by the font identifier, and at least one of the font identifiers identifying a font file referenced as style information in the text subtitle stream.
